(19) United States
(12) Patent Application Publication
(10) Pub. No.: US 2015/0287047 A1
(43) Pub. Date: Oct. 8, 2015

(54) Extracting Information from Chain-Store Websites

(71) Applicant: Google Inc., Mountain View, CA (US)

(72) Inventors: Jifeng Situ, Edgewater, NJ (US); Yihua Wu, Princeton Junction, NJ (US); Kun Fang, Beijing (CN); Hui Xu, Sunnyvale, CA (US); Erik Arjan Hendriks, Sunnyvale, CA (US); Changxun Wu, Cupertino, CA (US); Neha Sugandh, Jersey City, NJ (US); Jianning Ding, Beijing (CN)

(21) Appl. No.: 13/921,440

(22) Filed: Jun. 19, 2013

(51) Int. Cl. G06Q 30/02

(52) U.S. Cl. CPC G06Q 30/0201

(57) ABSTRACT

Provided is a process of extracting structured chain-store data from chain-store websites, the process including: identifying, via a processor, a store-locator webpage from a store website; querying the store-locator webpage for store locations in a geographic area; detecting a repeating pattern in a document object model (DOM) of a responsive webpage returned by the store website, the repeating pattern containing location information for stores in the geographic area; extracting, from the repeating pattern, location information for the stores in the geographic area; and storing the location information in a business listing repository.

### BACKGROUND OF THE INVENTION

1. Field of the Invention

The present invention relates generally to web services and, more specifically, to augmenting a business listing repository by extracting information about individual locations of chain stores from chain-store websites.

2. Description of the Related Art

Many web services and mobile-applications benefit from up-to-date information about individual stores in large chains, e.g., various “big-box” retailers, chain coffee shops, multi-branch banks, or automotive-service centers, some of which have hundreds or thousands of store locations and many of which frequently add and close store locations. Information about individual store locations is generally available from chain-store websites. But this information is expensive to extract manually, for instance by having a human navigate a web browser to each chain-store uniform resource locator (URL), click through to a store locator web page, enter each zip code in the United States, parse out individual store information (e.g., address, phone number, hours, etc.) from the results, and merge this information into a business listing repository. And scripting such extractions is difficult because chain-stores generally do not follow the same format for store-locator web pages or displaying information about individual stores.

Further, this information on chain-store websites can be difficult to extract by merely crawling the web because the store listings are often hidden behind web forms that require a user to enter a zip code and click a particular button, rather than simply following hyperlinks to listings of individual stores without interacting with web forms. And exploring chain store websites programmatically can be difficult because some stores operate web servers that interpret excessive traffic from a single computing device as an attack and restrict subsequent access to the website from that device.

### SUMMARY OF THE INVENTION

The following is a non-exhaustive listing of some aspects of the present techniques. These and other aspects are described in the following disclosure.

In some aspects, the present techniques include a process of extracting structured chain-store data from chain-store websites, the process including: identifying, via a processor, a store-locator webpage from a store website; querying the store-locator webpage for store locations in a geographic area; detecting a repeating pattern in a document object model (DOM) of a responsive webpage returned by the store website, the repeating pattern containing location information for stores in the geographic area; extracting, from the repeating pattern, location information (and in some cases, other information noted below, including hours, menus, and phone numbers) for the stores in the geographic area; and storing the location information in a business listing repository.

Some aspects include a tangible, machine-readable, non-transitory medium storing instructions that when executed by a data processing apparatus cause the data processing apparatus to perform operations including the above-described process.

Some aspects include a system, including: one or more processors; memory storing instructions that when executed by one or more of the one or more processors cause the processors to effectuate operations including the above-described process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 shows an embodiment of a chain-store data extractor;

FIG. 2 shows an embodiment of a process for identifying store-locator webpages of chain-store websites;

FIG. 3 shows an embodiment of a process for extracting structured data about chain-store locations from chain-store websites; and

FIG. 4 shows an example of a computer system by which the various embodiments described herein are implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

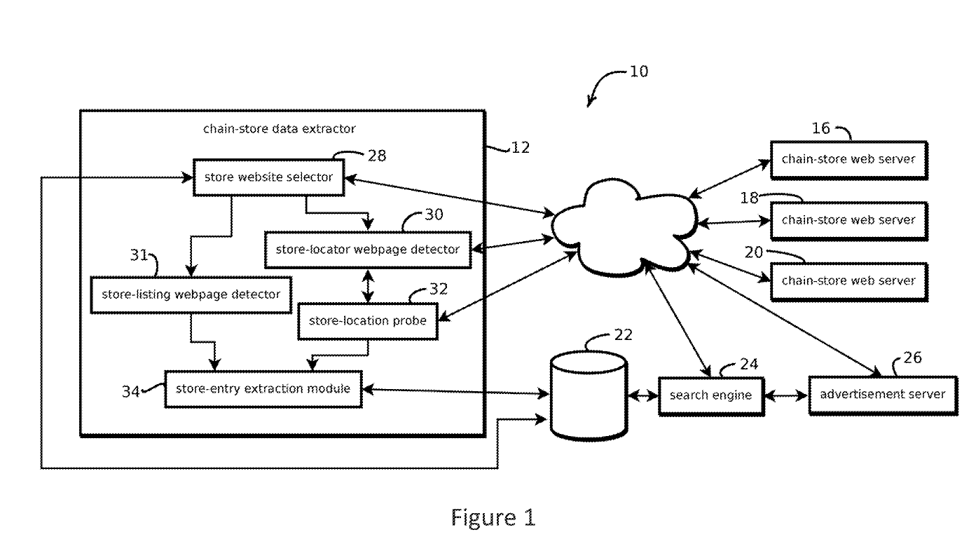

FIG. 1 shows a computing environment 10 having a chain-store data extractor 12 that, in some embodiments, addresses some (or, in some cases, all) of the above-mentioned challenges to maintaining a business listing repository including chain stores. Some embodiments automatically identify the websites of the top chain stores based on website impressions; detect a store-locator webpage within websites of those chain stores; submit each US zip code (or other geographic designations) to those store-locator webpages; and extract from the responsive webpages addresses, hours, phone numbers, and other data about each store location within each chain for addition to a business listing repository. Further, embodiments extract such information without requiring store-specific scripting, without requiring human assistance to navigate through the websites at issue, and without imposing an excessive load on the chain-store website from brute-force attempts to identify a store-locator webpage. Not all embodiments, however, provide all of these benefits, and some embodiments may provide other benefits, as various engineering and cost trade-offs are envisioned.

For example, an embodiment may determine that a given chain-store receives more than a threshold amount of web traffic based on click-throughs from search results including the chain-store website, for instance click-throughs placing the store in the top 10,000 websites or store websites by this measure. This chain-store website likely has store-locator webpage by which store locations are identified, but the website's layout and organization likely is relatively unstructured, for example differing from the layout and organization of other chain-store websites. Due to the lack of consistent industry-wide website formatting, the store-locator webpage is likely not readily identifiable programmatically, as the store may use a different resource naming scheme from other stores.

Accordingly, some embodiments crawl the webpages of this chain-store website, returning for example, webpages relating to the terms of use, products being sold, check-out webpages, webpages generally about the company, and the like, and potentially including a webpage through which individuals store locations are identified. Embodiments detect within this set of webpages the store-locator webpage by detecting the presence of certain keywords, terms in the URL of the webpage, and web forms through which store location search parameters are submitted. (Or for smaller chains, some embodiments detect a chain-store listing webpage having a listing of all the stores based on a repeating pattern within the webpage corresponding to each store in the list.) Candidate store-locator webpages are confirmed by submitting, via a web form, store location search parameters with relatively expansive criteria, for example any store within 5,000 miles of zip code 78701, and detecting in the responsive webpage a listing of stores, which is often indicated by a repeating pattern within the webpage.

Having identified the store-locator webpage, embodiments then iterate through a list of zip codes, or other identifiers of geographic areas, and extract from the responsive webpages information about individual store locations. When extracting this information, some embodiments detect the presence of links to store-specific webpages, add those links to a search index (which may not include the URLs if those URLs are not otherwise linked to by other indexed webpages, as often occurs for webpages responsive to a web form), and follow those links to extract additional information about the stores. The extracted store location information is added to a business listing repository, which is used to provide information about local businesses, including locations of chain stores. The data is extracted, in some cases, using the features of the computing environment 10.

As shown in FIG. 1, the computing environment 10 includes, in addition to the chain-store data extractor 12, the Internet 14, chain-store web servers 16, 18, and 20, a business listing repository 22, a search engine 24, and an advertisement server 26. The components of the computing environment 10 are geographically distributed and communicate with one another through the Internet 14 and various other networks, such as local-area networks, cellular networks, wireless area networks, and the like.

The chain store web servers 16, 18, and 20 each host a chain-store website associated with a different chain-store. Three web servers are shown as examples, but embodiments are expected to interface with web-scale sets of web servers numbering in the thousands, tens of thousands, or hundreds of thousands, depending on thresholds set and the amount of time and computing resources available for analyzing a given set of web servers. Each chain-store web server is associated with a different base URL, which returns a top-level or initial webpage of the website. The web servers host various webpages and other resources of the corresponding websites, which are accessible through the web servers 16, 18, and 20 by appending corresponding strings to the base URL and requesting the corresponding resource. In some cases, information in the URL naming scheme is used to detect store-locator webpages.

Returned webpages often include instructions for displaying the webpage and forming a corresponding document object model (DOM) of the webpage. The instructions generally include hypertext markup language (HTML), cascading style sheets (CSS), and JavaScript™ or various other scripting languages, such as Adobe Flash™. In some cases, the DOM is constructed, in part, by the scripts, so some embodiments execute these scripts before extracting store-location information, as the initial HTML served by the web-server may not include the information to be extracted or detected.

The business listing repository 22, in some embodiments, includes a listing of local business records, each local business record having data about an individual business location. Such data may include a unique identifier of the individual business location, a geographic address of the business location (such as a street address or a latitude and longitude), operating hours of the business location, user reviews of the business location, a website URL of the business location, and a phone number of the business location. In some cases, the business listing repository contains a relatively comprehensive listing of all the businesses in a geographic area, such as an entire country or continent, including both chain stores and other types of businesses.

The search engine 24 of this embodiment both uses the business-listing repository to provide search results and provides user-interaction data by which top chain-store websites are identified. The illustrated search engine 24 is operative to index websites, receive search queries from users, and return responsive websites to the user in ranked order based on the index. The search index is augmented by some embodiments of the chain-store data extractor 12 to include URLs of individual store webpages of chain-stores, which in some cases are not accessible by crawling the web, but can be reached by submitting queries to a store-locator webpage (e.g., requesting stores near a given zip code, city, or state).

Further, in some cases, the search engine records click-through data for the search results, indicating how many users click through to a given website when searching for various search terms. In some cases, the click-through data reflects an amount of time the user spent at the responsive URL and is filtered to exclude click-throughs in which the user selected a different search result with them less than a threshold amount of time, as often occurs when users click through to a search result that does not correspond to their intent. This click-through data is used by some embodiments to identify large chain-store websites and store-locator webpages on those chain-store websites.

In some cases, the search engine 24 receives search queries that implicate records in the business listing repository 22, in which case the search engine 24 queries the business listing repository 24 for responsive data. Examples of responsive data include data indicating the location of a business, whether a search term corresponds to a business name, or a URL of a business. The search engine 24 also communicates with the advertisement server 26 to request advertisements based on search queries for presentation with search results.

In some embodiments, the advertisement server 26 provides advertisements for presentation along with search results sent from the search engine 24. Advertisements are selected, in some cases, based on a business name appearing in the business listing repository 22. For instance advertisers may bid on the opportunity to have such an advertisement shown alongside search results for a query implicating an individual location of a chain store, and based on the winning bid, an advertisement is selected.

In this embodiment, the chain-store data extractor 12 includes a store website selector 28, a store-locator webpage detector 30, a store-listing webpage detector 31, a store-location probe 32, and a store-entry extraction module 34. These components generally support two phases of operation: identifying chain-store websites and the store-locator (or store listing) webpages; and extracting structured data from the identified websites using the store-locator (or store listing) webpages.

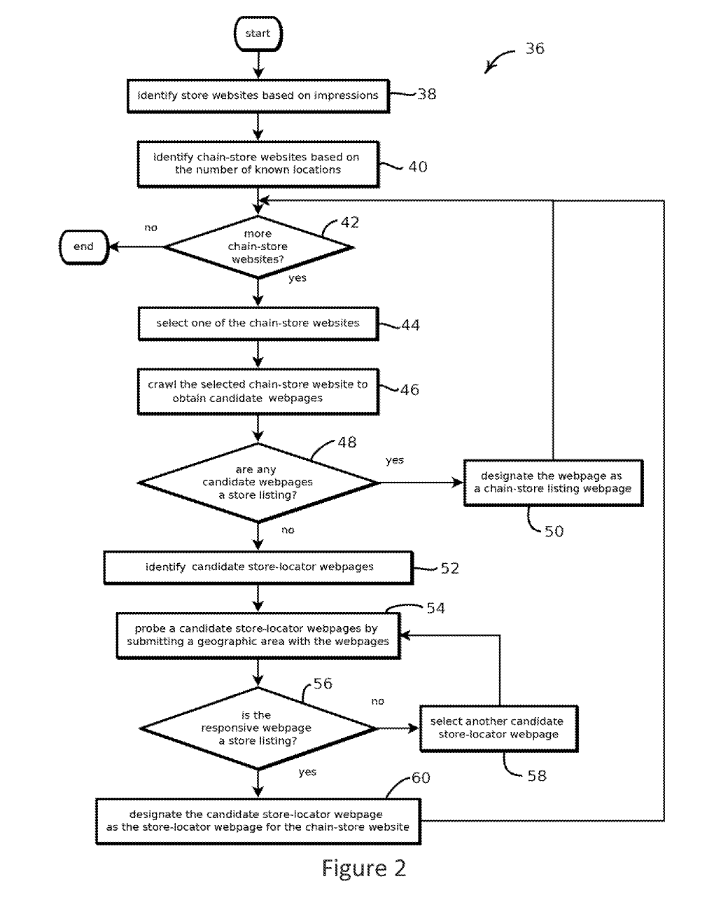

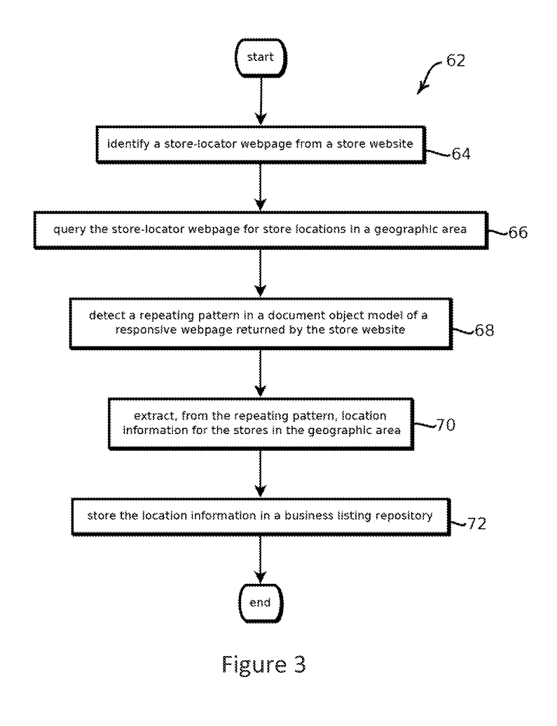

To this end, the illustrated store website selector 28 is operative to identify websites of chain stores. The store-locator webpage detector 30 then identifies within those websites a store-locator webpage, and the store-listing webpage detector identifies a store listing webpage, to the extent smaller chains offer a store listing webpage rather than a store locator webpage. Or a single module may determine whether a given webpage corresponds to one of these categories. The store-location probe 32 queries detected store-locator webpages with a plurality of different geographic area criteria to retrieve from the chain-store website listings of substantially all or all of the chain-store locations. And the store-entry extraction module 34 then extracts structured data from either the responsive listing of chain stores in webpages retrieved by the store-location probe 32 or the detected store-listing webpages. This structured data is then used to augment the business listing repository 22, for instance by 1) adding new records for new store locations that have been opened and are not reflected in the business listing repository 22, 2) deleting or flagging for review records of store locations in the business listing repository 22 that are no longer included in the chain-store website, or 3) supplementing or updating fields corresponding to individual store locations within the business listing repository, e.g., adding or updating business hours, telephone numbers, street addresses, URLs, and the like. To perform these functions, in some embodiments, the components of the chain-store data extractor 12 perform the processes described below with reference to FIGS. 2 and 3. But embodiments are not limited to implementations performing the specific examples of these processes.

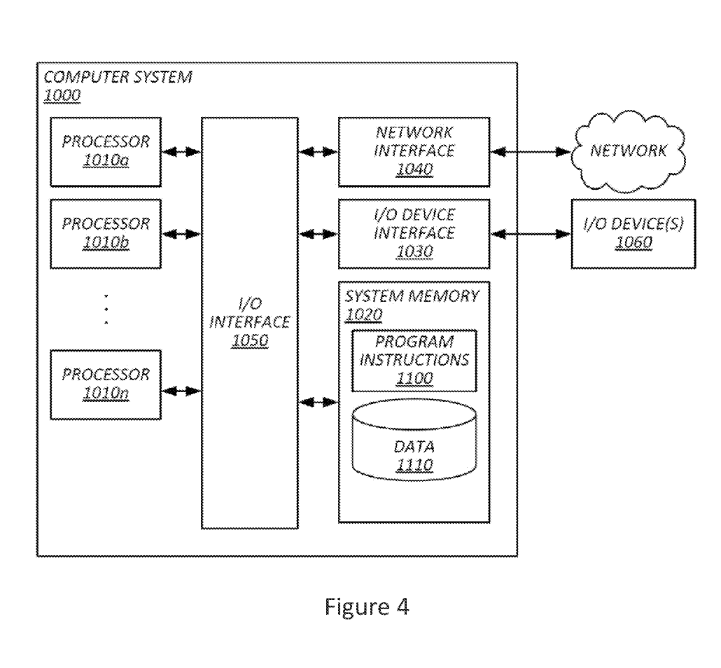

The chain-store data extractor 12 may be implemented by executing computer code stored on a tangible, non-transitory, machine-readable medium, examples of which are described below with reference to FIG. 4. The code may be executed by one or more of the computing devices described below with reference to FIG. 4. The components of the chain-store data extractor 12 are illustrated as discrete functional blocks, but it should be understood that embodiments are not limited to this particular arrangement. For example, code or hardware by which the functional blocks are implemented may be conjoined, subdivided, intermingled, co-located, or distributed, and the steps associated with the functionality may be performed serially or concurrently, depending upon the implementation.

For instance, embodiments processing a relatively large number of chain-store websites may map different chain-store websites to different instances of the chain-store data extractor 12 or different instances of components 30, 31, 32, or 34 of the chain-store data extractor 12, each executing in a different thread, core, virtual machine, or computing device. With concurrent processing, the different store websites may be processed at the same time, thereby expediting the analysis. Further, some embodiments process webpages of a given chain-store website concurrently by dividing the webpages among multiple instances of the chain-store detection engine 12 or components thereof.

FIG. 2 shows an embodiment of a process 36 for identifying store-locator webpages or store listing webpages of chain-store websites. In some cases, the process 36 is performed by the above-described store website selector 28, store-locator webpage detector 30, and store-listing webpage detector 31 of FIG. 1, but embodiments are not limited to those particular implementations. The process 36 is described as a serial process, iterating through each of a list of identified chain-store websites, but embodiments are consistent with a functional, parallelized approach in which portions of process 36 are mapped to each of a plurality of chain-store websites and executed concurrently.

In this example, the process 36 begins with identifying store websites based on impressions, as indicated by block 38. Impressions of store websites are available from the above-described search engine 24, which may store click-through data indicating the number of times users click through to a given store URL. As is apparent, a substantial portion of the web does not relate to stores, and among those websites that relate to stores, many such websites do not relate to chain stores. Manually classifying websites according to whether they relate to chain stores is relatively expensive, particularly given the frequency with which websites change. Focusing subsequent processing on website having more than a threshold number of impressions reduces the amount of computing power and network bandwidth consumed in the process 36, without necessarily requiring a human to manually classify websites as relating to chain stores, though embodiments are consistent with human involvement at various steps. Some embodiments rank websites based on the number of impressions and select those websites ranking in the top 10,000 websites or above some other threshold selected based on tradeoffs between comprehensiveness and speed.

The number of websites resulting from the identification of step 38 may include a relatively large number of false positives corresponding to popular websites of non-chain stores, for example stores with a single physical location and a large web presence. Accordingly, embodiments identify chain-store websites among the identified store websites based on a number of known locations of stores, as indicated by block 40. To this end, some embodiments query the business listing repository 22 for store locations corresponding to a URL of the respective potential chain-store websites, and discard from further processing those websites having fewer than a threshold number of locations in the business listing repository 22, for instance less than ten to exclude all but relatively large chain stores that are likely to benefit from programmatic analysis, or less than two to encompass smaller, but potentially fast-growing chain stores.

Next, in this embodiment, the process 36 includes determining whether more chain-store websites remain to be analyzed, as indicated by block 42. If all of the chain-store websites identified in step 40 have been processed, the process 36 ends. Alternatively, embodiments select one of the un-processed chain-store websites, as indicated by block 44, and the selected chain-store website is crawled to obtain candidate webpages, as indicated by block 46. Crawling the selected chain-store website includes requesting a top-level, introductory chain-store webpage from a chain-store web server, identifying links within the webpage, and following the links. And links within the responsive webpage are followed in a similar fashion, recursing through the website and obtaining a set of candidate webpages, of which typically a small subset relate to store locations.

The process 36 further includes determining whether any of the candidate webpages is a store listing, as indicated by block 48. Often smaller chain stores provide a single webpage having a listing of all of the stores within the chain, in contrast to larger chains having a store-locator webpage in which the user first enters criteria, such as the geographic area, to specify a subset of the stores of the chain. Detecting a single webpage (or a collection of pre-defined webpages, such as one per US state) having a store listing may shorten the process 36 and avoid additional processing to detect a store-locator webpage. Decision block 48 is shown as leading to two branches of process 36, one leading to block 50 and one leading to block 52. It should be understood that these branches, in some embodiments, are each performed in separate, parallel processes, each independently performing the preceding blocks to identify store location and other related information through two, independently applied techniques. For instance, the store-listing webpage detector 31 may detect store listings with a process parallel to a process by which the store-locator webpage detector 30. These modules 31 and 30 may interact in some embodiments, such that an identification of a store listing webpage stops or preempts store-locator webpage detection, vice versa, or the processes may be independent and parallel.

Store listings are detected based on signals in the DOM of the candidate webpage. Thus, determining whether the candidate webpage is a store listing includes fully rendering the webpage to obtain a complete DOM of the corresponding webpage, a step which may include executing scripts in the webpage that request additional data from the web server and determining when the corresponding webpage is rendered to completion. The DOM is a hierarchical arrangement in browser memory of webpage elements (e.g., i-frames, div boxes, tables, table cells, paragraphs, web forms, images, and the like), some of which include child elements, for instance paragraphs within div boxes or images within table cells. The DOM may be characterized as a collection of nodes (or elements) in a tree structure having a topmost node referred to as the document object. The HTML in a website, during rendering, is parsed into an initial document object model, and scripts executed when rendering the webpage may add elements to the document object, for example requesting store locations from the chain-store web server and inserting div boxes having paragraph describing those chain-store locations. Examples of automated browsers supporting script execution include those provided by the Selenium browser automation tool set available under an Apache License.

Aspects of the DOM indicate whether a given webpage has a store listing. For instance, keywords on the webpage (such as the text “store locations,” the term “address,” or the term “driving directions”) indicate that the webpage is a store listing and are detected as such. Further, formatting and location of these terms indicates a store listing, for instance the term “store location” positioned above a threshold height of the webpage is indicative of a store listing, as opposed to boilerplate text having this string. In another example, the same or similar keywords within the URL of the webpage is a signal indicative of a store listing.

In some cases, a store listing is detected based on a repeating pattern within the DOM. For instance, a plurality of stores are often listed within similar, sibling sub-trees of the DOM. Sub-trees are elements having child-elements, and similar sub-trees have the matching structures or nearly matching structures. By way of example, one repeating pattern may having in each cycle of the patter a sub-tree with a div box, the div box having each of a child div box with the text “address,” another child div box with the text “phone number,” and a child image element with a class attribute including the term “map.” Each sub-tree in the repeating pattern of this example would have the same or similar elements. And each cycle of the repeating pattern may be an immediate child of the same parent element, i.e., without intermediate elements. In some cases, text within each cycle of the pattern is a signal indicating that the pattern is a repeating cycle of entries about store locations. Such text include the terms “address,” “operating hours,” text matching a regular expression for a zip code or a telephone number, or text corresponding to a known location in the business listing repository 22, and the like. Similarly, attributes of elements, such as classes named with such keywords indicate cycles of the repeating pattern of store listings.

To identify these repeating patterns, embodiments recursively process the DOM, determining for each node whether that node has more than a threshold number of child nodes (for instance more than five) that are sufficiently similar or each include one or more keywords. The child nodes are deemed similar if they have, for example, the same number of child elements, the same set of child element types, the same set of child element classes (or other attributes), or match any combination of these criteria. More criteria may be applied to reduce the likelihood of false positives, at the risk of more false negatives. In some cases, elements are scored according to the number of criteria satisfied by their child elements, and the highest scoring element is selected as the repeating pattern, with the webpage yielding a response with the highest scoring repeating pattern being designated as a likely store-locator webpage. In some cases, the highest score among the candidate webpages is compared to a threshold to determine whether a store listing has been detected.

Upon determining that the candidate webpage is a store listing, the process 36 designates the webpage as a chain-store listing webpage, as indicated by block 50, and returns to block 42 to process other, not-yet processed chain-store websites. In some embodiments, once a store listings webpages is detected, patterns in a URL of the page are detected, and more pages are retrieved and processed based on the pattern. For instance, if a name of a US state appears in the URL, the state-name may be replaced with the names of other US states to retrieve store listing pages of a plurality of US states by iterating through the name of each US state and performing the steps of the process 36 on each responsive webpage. Or some embodiments may detect a zip code in the URL and request webpages of other URLs in which the portion reciting a zip code is iteratively changed through a list of zip codes.

Alternatively, as often occurs when the chain is relatively large and includes a store-locator webpage, the process 36 proceeds to identify candidate store-locator webpages, as indicated by block 52. Store-locator webpages generally include input fields, for example in a web form, for users to specify a geographic area in which they wish to locate stores. However, submitting queries for every web form provided on the chain-store website potentially increases the load of the web server and consumes an amount of network traffic to service the queries, many of which will yield non-responsive webpages, as many webpages include web forms but are not store-locator webpages. Indeed, some chain-store websites include several thousand or tens of thousands of such webpages. Consequently, policies of one on the web server may interpret the queries as an attack and block further requests. To avoid this result, some embodiments, filtered candidate webpages before submitting queries.

Such embodiments of the step 52 include steps to eliminate duplicate candidate store-locator webpages. Various criteria are applied to determine whether webpages are duplicative for the present purposes. For instance, webpages with differing visible text, but identical or similar web forms, are treated as duplicates in some cases, thereby causing all but one of the duplicates to be removed from further processing. For example, the action field of web forms in pairs of webpages is compared in some embodiments, while disregarding parameters of the action field, to determine whether the web forms match. Some embodiments also eliminate from further processing webpages lacking certain keywords, such as those described above relating to store locations, and webpages lacking a web form. In some cases, step 52 along with keyword and web form filtering reduces the candidate store-locator webpages from tens of thousands to a number on the order of ten, an amount of webpages that when probed in subsequent steps is relatively un-burdensome to the chain-store web servers.

Next, in this embodiment, the process 36 includes probing the remaining candidate store-locator webpages by submitting a geographic area with the webpages, as indicated by block 54. Probing the candidate store-locator webpages includes populating text entry fields of web forms, for instance by entering a zip code, state, or city and, in some cases, providing a search radius or search area. To reduce the likelihood of false negatives, some embodiments select a relatively large search area, for example the entire United States, an entire country, or a radius of more than 5,000 miles, thereby increasing the likelihood that at least some store locations will be responsive to the query and indicate whether the store-locator webpage has been identified.

The process 36 proceeds to determine whether the responsive webpage is a store listing, as indicated in block 56. Determining whether the responsive webpage is a store listing includes the steps described above with reference to block 48 in which the candidate webpages for identifying a store-locator webpage were first processed to identify store listings. Thus, some embodiments detect keywords within the webpage, keywords within the URL of the webpage, or a repeating pattern in the DOM.

Upon determining that the webpage is not a store listing, the process 36 proceeds to block 58, whereby another candidate store-locator webpage is selected, and steps 54 and 56 are repeated. Alternatively, upon determining that the responsive webpage is a store listing, the process proceeds to block 60, and the responsive webpage is designated as the store-locator webpage for the chain-store website. Designating the candidate webpage as the store-locator webpage for the chain-store website includes storing in memory and association between the chain-store and the URL of the store-locator webpage, for example by adding the URL to store location records of the chain in the business listing repository 22 and associating the name of the chain-store with the URL in an index of the search engine 24 of FIG. 1. Next, the store-locator webpage, or store listing webpage, is used in the process of FIG. 3 to extract structured data about individual locations of chain stores, though these processes need not both be performed in some embodiments, as they have independent applications, which is not to suggest that any other feature is required.

FIG. 3 shows an embodiment of a process 62 for extracting structured data about chain-store locations from chain-store websites. The process 62, in some cases, is performed by the components 32 and 34 of the above-described chain-store data extractor 12 of FIG. 1, but is not limited to those implementations. The process 62 extracts from chain-store websites various attributes of individual store locations, such as street address, menus, operating hours, telephone number, and store-location-specific webpage URLs. This data is formatted as structured data, with fields being labeled according to the parameter to which they correspond, e.g., as key-value pairs, and the structured data is used to augment a business listing repository, such as the repository 22 described above with reference to FIG. 1.

The process 62 begins with identifying a store-locator webpage from a store website, as indicated by block 64. Identifying the store-locator webpage, in some cases, includes performing the process of FIG. 2 described above, but in other cases, store-locator webpages may be provided through other techniques, for example through a manually provided work list entered by a human operator.

Next, the process 62 includes querying the store-locator webpage for store locations in a geographic area, as indicated by block 66. This step, in some embodiments, includes identifying within a DOM of the store-locator webpage an element corresponding to a web form, modifying text input elements of the web form to populate the web form with an identifier of the geographic area, and submitting the web form information to the store website, for example by identifying a submit button of the web form and engaging the submit button (each such step being performed automatically in some embodiments, without user intervention, like the other actions described herein). The identifier of the geographic area, in some cases is a zip code or a US state. In some cases, step 66 and the subsequent steps are repeated for each of a plurality of geographic areas, for example every US zip code or every US state to extract a comprehensive set of information about all store locations within the United States or, using similar techniques, some other country.

The process 62 further includes detecting a repeating pattern in a DOM of a responsive webpage returned by the store website, as indicated by block 68. In some cases, the responsive webpage is rendered to completion to fully construct the DOM and the pattern is the detected with the techniques described above with reference to block 48 of FIG. 2. Thus, some embodiments detect keywords within the webpage, keywords within the URL of the webpage, and a repeating pattern in the DOM to identify a store listing.

The process 62 further includes extracting, from the repeating pattern, location information for stores in the geographic area, as indicated by block 70. Extracting the location information, in some embodiments, includes iterating through each cycle of the pattern, and within each cycle, extracting information corresponding to an individual store location from the corresponding sub-tree of the DOM.

As noted above, each cycle of the repeating pattern may be represented, for example, in a div box serving as root node of a subtree of the DOM, and various fields for an individual store location may positioned within this subtree in child elements that correspond to various parameters of the store location. For instance a div box having the class of “StreetAddress” may be identified in the subtree of a given cycle, and an “innerHTML” attribute of that give box may include the street address of the chain-store location. In another example, street addresses, telephone numbers, and other parameters having text signatures are detected with regular expressions configured to identify strings of text corresponding to a signature expected for a street address, a telephone number, or operating hours, or the like.

In some cases, a store-location-specific webpage URL is extracted from each cycle of the repeating pattern, and the store-location-specific webpage is retrieved. Some chain-stores included within the store specific webpage additional information about the store location, for example the operating hours, and this additional information is extracted from the store specific page by retrieving the webpage and using similar techniques to those described above.

Identifying information about individual store locations based on patterns, e.g., in a DOM or in visible text, accommodates a relatively wide range of different presentation formats for store location information used by differing websites. Consequently, some embodiments mitigate the need for chain-specific scripts to extract information or human operators who would otherwise manually identify the information.

In some cases, mobile webpages are requested from the chain-store web servers because such webpages often contain the same information as the full website, but with simplified presentation that is less prone to being erroneously parsed. To this end, the webpages are requested with an application layer protocol request (e.g. hypertext transport protocol or SPDY™) including a user agent header field set to indicate that the requesting entity is a mobile device, such as a smart phone. The web servers generally parse the user agent field from the request and respond by sending a version of the website corresponding to the user agent.

Next, the process 62 includes storing the location information in a business listing repository, as indicated by block 72. Various cases occur depending on whether an entry is already present or is different in some respects. In some embodiments, information is stored by first querying the business listing repository to determine whether an existing entry is present. If the entry is present, the answer entry is compared to the extracted information to identify updated attributes of the chain-store location, such as an updated phone number, and the updated data is added to the business listing repository, replacing the outdated data. In cases in which the business listing repository does not include a corresponding entry, the structured data is added to the business listing repository or is added to a work list for a human reviewer to investigate and determine whether to add. In some cases, after performing the process 62 for each of the geographic areas in a given country, the business listing repository 72 is queried to identify all other listed chain-store locations for the chain at issue, and any chain-store locations in the business listing repository that were not also identified by extracting location information for stores are deleted from the business listing repository or added to a work list for a human reviewer to investigate and evaluate for deletion.

Thus, some embodiments of the process 62 and process 36 programmatically extract chain-store location information from chain-store websites with relatively little human intervention or guidance, while accommodating chain-store websites having varying layouts, structures, and presentation of data, and without burdening the chain-store web servers with excessive query submissions. Embodiments update a business listing with chain-store location information extracted at a web scale relatively quickly, such that information about a large number of chain-store locations, data that potential changes relatively frequently, can be kept up-to-date. Not all embodiments, however, necessarily provide all of these benefits, as various engineering and cost trade-offs are envisioned.

In situations in which the systems discussed here collect personal information about users, or may make use of personal information, the users may be provided with an opportunity to control whether programs or features collect user information (e.g., information about a user's social network, social actions or activities, preferences, or current location), or to control whether and/or how such information is used (e.g., to provide content that may be more relevant to the user). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user, stored, and used by a content server.

FIG. 4 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030 and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending or storing instructions or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a”, “an” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Further, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device.

What is claimed is:

1. A method of extracting structured chain-store data from chain-store websites, the method comprising:
identifying, via a processor, a store-locator webpage from a store website;
querying the store-locator webpage for store locations in a geographic area;
detecting a repeating pattern in a document object model (DOM) of a responsive webpage returned by the store website, the repeating pattern containing location information for stores in the geographic area;
extracting, from the repeating pattern, location information for the stores in the geographic area; and
storing the location information in a business listing repository.

2. The method of claim 1, wherein identifying a store-locator webpage comprises:
identifying webpage from the store website having keywords that match a threshold number of keywords in a set of keywords expected on a store-locator webpage.

3. The method of claim 1, further comprising:
querying the store-locator webpage for locations in a plurality of geographic areas.

4. The method of claim 1, wherein the repeating pattern includes contact information for the stores, and further comprising:
storing the contact information for the stores in a business listing repository.

5. The method of claim 1, further comprising:
obtaining numbers of impressions of candidate store websites of candidate stores; and
selecting candidate store websites having more than a threshold number of impressions.

6. The method of claim 5, further comprising:
for at least one of the selected candidate store websites, determining that a corresponding candidate store is a chain store based on the at least one selected candidate store website corresponding to more than a threshold number of store locations in a business listing repository.

7. The method of claim 1, wherein identifying a store-locator webpage comprises:
crawling the store website to obtain candidate store-locator webpages; and
selecting a subset of the candidate store-locator webpages based on:
keywords corresponding to store location in the candidate store-locator webpages;
a uniform resource locator (URL) of the candidate store-locator webpages including keywords corresponding to store location;
click-throughs by search-engine users to the candidate store-locator webpages after searching for search terms corresponding to store location.

8. The method of claim 7, wherein crawling the store website comprises:
requesting the candidate store-locator webpages with an application layer protocol request having a user-agent value corresponding to a mobile device from a computing device that is not a mobile device.

9. The method of claim 7, further comprising:
removing from the subset of the candidate store-locator webpages those candidate store-locator webpages having a web-form that matches a web form in another candidate store-locator webpage in the subset, wherein web-forms are determined to match when action fields of the web-forms are identical, disregarding differences in parameters of the actions fields.

10. The method of claim 7, further comprising:
probing the candidate store-locator webpages by populating and submitting web forms of the candidate store-locator web pages; and
determining that a responsive web-page contains a listing of store locations.

11. The method of claim 10, wherein populating and submitting the web forms comprises selecting a geographic area that encompasses a substantial portion of a country.

12. The method of claim 1, further comprising:
identifying a store-listing webpage from another store website, the other store website not having a store-locator webpage, and wherein the store-listing webpage is identified by crawling the other store website and selecting the store-listing webpage based on another repeating pattern in a DOM of returned webpages, the other repeating pattern including in each cycle of the pattern a street address;
extracting, from the other repeating pattern, location information for the corresponding stores; and
storing the location information in a business listing repository.

13. The method of claim 1, wherein querying the store-locator webpage for store locations in the geographic area comprises:
retrieving a zip code from a list of zip codes;
entering the zip code in a web form of the store-locator webpage; and
submitting the web form.

14. The method of claim 1, wherein detecting the repeating pattern comprises:
rendering the responsive webpage by executing scripts on the responsive webpage operative to request additional data from the store website and modify the DOM; and
determining that the scripts have finished modifying the DOM before detecting the repeating pattern.

15. The method of claim 1, wherein detecting the repeating pattern comprises:
segmenting the DOM into sub-trees; and
determining that at least some of the sub-trees constitute the repeating pattern based on matching DOM elements in the at least some of the sub-trees.

16. The method of claim 1, wherein extracting, from the repeating pattern, location information for the stores in the geographic area comprises:
determining that the repeating pattern includes a link to a store-hours webpage;
requesting a store-hours webpage at the link; and
extracting store hours from the store-hours webpage.

17. The method of claim 16, comprising:
adding the store-hours webpage to a search index and associating the store-hours web page with keywords relating to the store and hours in the search index.

18. The method of claim 1, comprising:
receiving a request relating to information in the business listing repository;
selecting an advertisement based on the request; and
sending the advertisement for display to a user device associated with the request.

19. A tangible, machine-readable, non-transitory medium storing instructions that when executed by a data processing apparatus cause the data processing apparatus to perform operations comprising:
identifying, via a processor, a store-locator webpage from a store website;
querying the store-locator webpage for store locations in a geographic area;
detecting a repeating pattern in a document object model (DOM) of a responsive webpage returned by the store website, the repeating pattern containing location information for stores in the geographic area;
extracting, from the repeating pattern, location information for the stores in the geographic area; and
storing the location information in a business listing repository.

20. A system, comprising:
one or more processors;
memory storing instructions that when executed by one or more of the one or more processors cause the processors to effectuate operations comprising:
identifying a store-locator webpage from a store website;
querying the store-locator webpage for store locations in a geographic area;
detecting a repeating pattern in a document object model (DOM) of a responsive webpage returned by the store website, the repeating pattern containing location information for stores in the geographic area;
extracting, from the repeating pattern, location information for the stores in the geographic area; and
storing the location information in a business listing repository.
